(19) United States
(12) Patent Application Publication
(10) Pub. No.: US 2021/0222717 A1
(43) Pub. Date: Jul. 22, 2021

(54) ASSEMBLY BODY

(71) Applicant: KABUSHIKI KAISHA TOKAI-RIKA-DENKI-SEISAKUSHO, Aichi-ken (JP)

(72) Inventors: Satoshi YOKOI, Aichi-ken (JP); Kenichi KAWAGUCHI, Aichi-ken (JP); Yasuo TAKADA, Aichi-ken (JP); Tatsuya NAKAYAMA, Aichi-ken (JP); Kiyotaka KINOSHITA, Aichi-ken (JP); Atsushi TAKEUCHI, Aichi-ken (JP)

(21) Appl. No.: 17/149,777

(22) Filed: Jan. 15, 2021

(30) Foreign Application Priority Data
Jan. 17, 2020 (JP) 2020-006348

(51) Int. Cl. F16B 21/08; F16B 5/06

(52) U.S. Cl. CPC F16B 21/086; F16B 5/0664; F16B 5/0642

(57) ABSTRACT

In an assembly structure, an insertion body is inserted into an assembly body, insertion claws of the insertion body tilt assembly claws of a rigid member of the assembly body, and an elastic member of the assembly body allows the tilting of the assembly claws, whereby the insertion claws are inserted into insertion holes in the assembly claws, and the insertion body is assembled to the assembly body. Here, slits are formed through the rigid member around the assembly claws. For this reason, the assembly claws can easily be tilted by the insertion claws, and the insertion body can easily be assembled to the assembly body.

### CROSS-REFERENCE TO RELATED APPLICATION

This application is based on and claims priority under 35 USC 119 from Japanese Patent Application No. 2020-6348 filed on Jan. 17, 2020, the disclosure of which is incorporated by reference herein.

### BACKGROUND

### Technical Field

The present invention relates to an assembly body in which an assembly partner is assembled to an assembly member.

### Related Art

Japanese Patent Application Laid-open No. 2001-91995 discloses a waterproof case where an elastomer material covers the outside of a plastic material in a front case, a catch receiving piece of a rear case becomes elastically deformed so that a catch piece inside the front case (inside the plastic material) becomes engaged with a catch groove in the catch receiving piece, whereby the rear case is assembled to the front case (the plastic material and the elastomer material).

Here, in this kind of waterproof case, it is preferred that the rear case be able to easily be assembled to the front case (the plastic material and the elastomer material) even if the catch receiving piece is not easily elastically deformed.

### SUMMARY

In consideration of the above circumstances, it is an object of the present invention to obtain an assembly body in which an assembly partner can easily be assembled to an assembly member.

An assembly body of a first aspect of the invention includes: an assembly member that is provided with an assembly portion, has a through hole provided around the assembly portion, and to which an assembly partner is assembled as a result of the assembly portion being displaced and becoming engaged with an engagement portion of the assembly partner; and a cover member that covers a side of the assembly member opposite an engagement portion side, is configured to be more elastic than the assembly member, and with its elasticity allows displacement of the assembly portion.

In the assembly body of the first aspect of the invention, the assembly portion of the assembly member is displaced and becomes engaged with the engagement portion of the assembly partner, whereby the assembly partner is assembled to the assembly member. Furthermore, the cover member covers the side of the assembly member opposite the engagement portion side, is configured to be more elastic than the assembly member, and with its elasticity allows the displacement of the assembly portion.

Here, the through hole is provided around the assembly portion of the assembly member. For this reason, the assembly portion can easily be displaced, the assembly portion can easily be engaged with the engagement portion, and the assembly partner can easily be assembled to the assembly member.

An assembly body of a second aspect of the invention is the assembly body of the first aspect of the invention, wherein the assembly portion is configured to be tiltable, and the through hole is disposed from a tilting distal end side of the assembly portion to a tilting base end side beyond a part of the assembly portion that engages with the engagement portion.

In the assembly body of the second aspect of the invention, the assembly portion is configured to be tiltable.

Here, the through hole is disposed from the tilting distal end side of the assembly portion to the tilting base end side beyond the part of the assembly portion that engages with the engagement portion. For this reason, the assembly portion can effectively be tilted.

An assembly body of a third aspect of the invention is the assembly body of the first aspect or the second aspect of the invention, further comprising a passage portion that is provided at the assembly member and through which the engagement portion passes to reach the assembly portion.

In the assembly body of the third aspect of the invention, the engagement portion passes through the passage portion of the assembly member to reach the assembly portion. For this reason, the engagement portion can easily be made to reach the assembly portion.

An assembly body of a fourth aspect of the invention is the assembly body of any one of the first aspect to the third aspect of the invention, wherein the assembly portion is provided at a tubular part of the assembly member.

In the assembly body of the fourth aspect of the invention, the assembly portion is provided at the tubular part of the assembly member. For this reason, even in a case where the tubular part of the assembly member is not easily displaced, the assembly portion can easily be displaced because the through hole is provided around the assembly portion of the assembly member.

An assembly body of a fifth aspect of the invention is the assembly body of any one of the first aspect to the fourth aspect of the invention, wherein the cover member limits ingress of liquid to an assembly member side.

In the assembly body of the fifth aspect of the invention, the cover member limits the ingress of liquid to the assembly member side. For this reason, the ingress of liquid to the assembly member side can be limited.

### BRIEF DESCRIPTION OF THE DRAWINGS

An exemplary embodiment of the invention will be described in detail based on the following figures, wherein:

FIG. 1 is an exploded perspective view, seen obliquely from the front and left side, showing an assembly structure pertaining to the embodiment of the invention:

FIG. 2 is a perspective view, seen obliquely from the front and left side, showing main portions of an assembly body in the assembly structure pertaining to the embodiment of the invention; and

FIG. 3 is a sectional view, seen from the left side, showing the main portions of the assembly structure pertaining to the embodiment of the invention.

### DETAILED DESCRIPTION

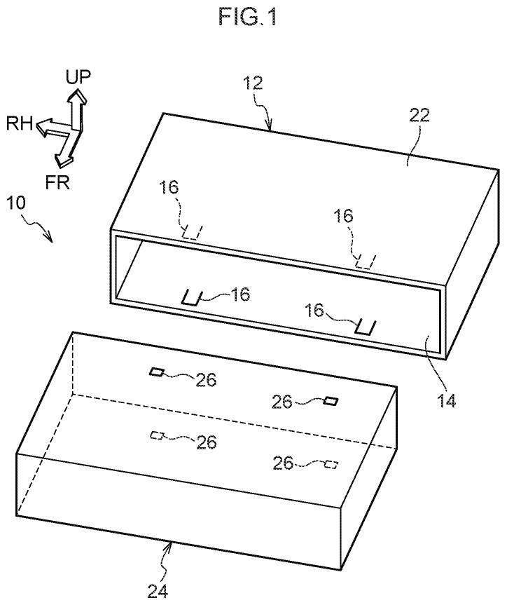

In FIG. 1, an assembly structure 10 pertaining to an embodiment of the invention is shown in an exploded perspective view seen obliquely from the front and left side. In the drawings, arrow FR indicates a forward direction of the assembly structure 10, arrow RH indicates a rightward direction of the assembly structure 10, and arrow UP indicates an upward direction of the assembly structure 10.

As shown in FIG. 1, the assembly structure 10 pertaining to this embodiment is provided with an assembly body 12 in the shape of a bottomed rectangular tube, and the inside of the assembly body 12 opens forward.

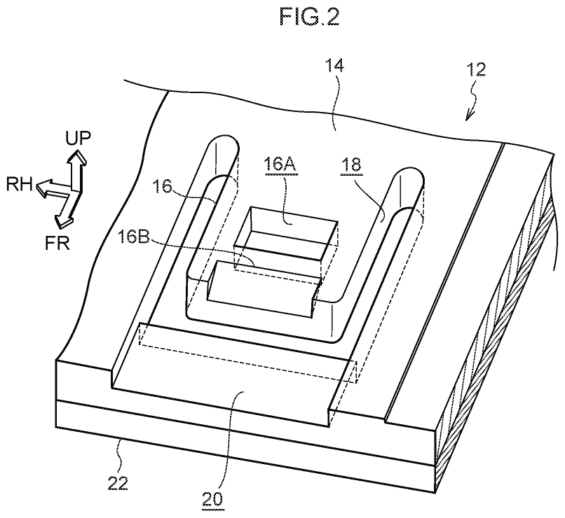

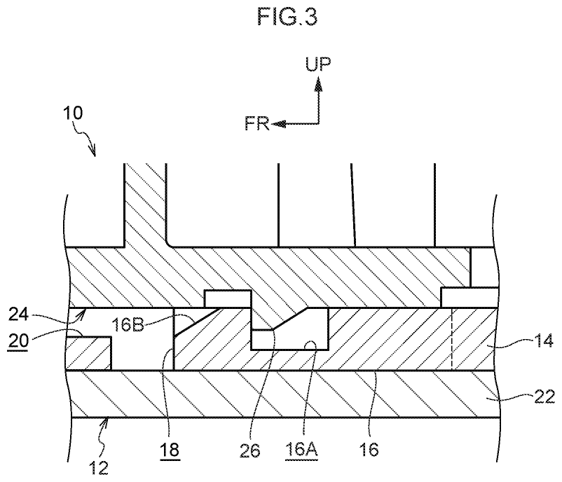

In the inside part of the assembly body 12, a rigid member 14 (see FIG. 2 and FIG. 3) in the shape of a bottomed rectangular tube and serving as an assembly member (a primary member) is provided, and the rigid member 14 is made of a rigid resin and configures an inner surface of the assembly body 12. In the left portions and the right portions of the upper wall and the lower wall of the rigid member 14, assembly claws 16 substantially in the shape of rectangular plates and serving as assembly portions are formed, and the assembly claws 16 are disposed in the neighborhood of the front end of the rigid member 14. Slits 18 in the shape of a “U” when seen in a front elevation view and serving as through holes are formed through the rigid member 14 around the assembly claws 16, and the slits 18 are disposed on the front sides, the left sides, and the right sides of the assembly claws 16.

In the central portions of the assembly claws 16, insertion holes 16A in the shape of a cuboid and serving as assembly sites are formed, and the left portions and the right portions of the slits 18 extend to the rear sides of the insertion holes 16A (base end sides of the assembly claws 16). The insertion holes 16A open to the inside of the assembly body 12 (the inside of the rigid member 14), and the front surfaces of the insertion holes 16A are disposed perpendicular to the front and rear direction. In the assembly claws 16, abutment portions 16B trapezoidal in cross section are formed on the front sides of the insertion holes 16A (distal end sides of the assembly claws 16). The front surfaces of the abutment portions 16B are inclined in a direction inward of the assembly body 12 heading from the front surfaces of the assembly claws 16 rearward, and top surfaces of the abutment portions 16B are disposed perpendicular to the up and down direction. The rear surfaces of the abutment portions 16B are configured by the front surfaces of the insertion holes 16A, the right and left direction middle positions of the abutment portions 16B coincide with the right and left direction middle positions of the insertion holes 16A, and the right and left direction dimension of the abutment portions 16B is configured to be greater than the right and left direction dimension of the insertion holes 16A.

In the rigid member 14, passage grooves 20 in the shape of a cuboid and serving as passage portions are formed on the front sides of the slits 18, and the passage grooves 20 open to the inside of the rigid member 14. The passage grooves 20 communicate the slits 18 to the front side of the rigid member 14, and the passage grooves 20 allow the right and left direction entireties of the slits 18 to open to the front side of the rigid member 14.

The outside part of the assembly body 12 is provided with an elastic member 22 (see FIG. 2 and FIG. 3) in the shape of a bottomed rectangular tube and serving as a cover member (a secondary member), and the elastic member 22 configures an outer surface of the assembly body 12. The elastic member 22 is formed by double molding with respect to the rigid member 14 and is anchored to the rigid member 14, and the elastic member 22 covers the outside of the rigid member 14 (including the assembly claws 16 and the slits 18) and closes off the entireties of the slits 18. The elastic member 22 is made of a thermoplastic elastomer (TPE), and the elastic member 22 is configured to be more elastic (configured to be less rigid) than the rigid member 14 and limits ingress of water (liquid) into the assembly body 12 (the rigid member 14 side).

The assembly structure 10 is provided with an insertion body 24 (see FIG. 3) substantially in the shape of a cuboid and serving as an assembly partner (engagement body), and the insertion body 24 is, like the rigid member 14 of the assembly body 12, made of a rigid resin. The rear portion of the insertion body 24 is inserted into the assembly body 12 from the front side and is mated with the inside of the assembly body 12, and further movement of the insertion body 24 into the assembly body 12 (rearward) is limited.

On the left portions and the right portions of the upper surface and the lower surface of the insertion body 24, insertion claws 26 trapezoidal in cross section and serving as engagement portions are integrally formed, and the insertion claws 26 are disposed in the rear portion of the insertion body 24. The rear surfaces of the insertion claws 26 are inclined in a direction outward of the insertion body 24 heading forward, the top surfaces of the insertion claws 26 are disposed perpendicular to the up and down direction, and the front surfaces of the insertion claws 26 are disposed perpendicular to the front and rear direction. The insertion claws 26 are inserted into (engaged with) the insertion holes 16A in the rigid member 14 (the assembly claws 16), and the front surfaces of the insertion claws 26 are abutted against the front surfaces of the insertion holes 16A. For this reason, forward movement of the insertion claws 26 is limited by the insertion holes 16A, forward movement of the insertion body 24 with respect to the assembly body 12 is limited, and the assembly body 12 and the insertion body 24 are assembled to each other.

Next, the action of this embodiment will be described.

In the assembly structure 10 with the above configuration, when the assembly body 12 (the rigid member 14 and the elastic member 22) and the insertion body 24 are to be assembled to each other, the insertion body 24 is inserted into the assembly body 12 (into the rigid member 14) from the front side. For this reason, the insertion claws 26 of the insertion body 24 are passed through the passage grooves 20 and the front portions of the slits 18 in the rigid member 14. Moreover, particularly the rear surfaces of the insertion claws 26 are abutted against the front surfaces and then the top surfaces of the abutment portions 16B of the assembly claws 16 in the rigid member 14, whereby the assembly claws 16 become elastically tilted (displaced) about their rear end portions toward the elastic member 22, and the elastic member 22 becomes elastically deformed and allows the elastic tilting of the assembly claws 16. Then, the insertion claws 26 pass over the abutment portions 16B, and the assembly claws 16 and the elastic member 22 become elastically restored, whereby the insertion claws 26 are inserted into the insertion holes 16A in the assembly claws 16, and the front surfaces of the insertion claws 26 are abutted against the front surfaces of the insertion holes 16A. Because of this, forward movement of the insertion body 24 with respect to the assembly body 12 is limited, and the assembly body 12 and the insertion body 24 are assembled to each other.

Here, the slits 18 are formed through the rigid member 14 around the assembly claws 16. For this reason, even in a case where the insertion claws 26 of the insertion body 24 are not easily elastically displaced, the assembly claws 16 can easily be elastically tilted by the insertion claws 26, the insertion claws 26 can easily be inserted into the insertion holes 16A in the assembly claws 16, the assembly load on the assembly body 12 (the rigid member 14) and the insertion body 24 can be reduced, and the assembly body 12 and the insertion body 24 can easily be assembled to each other.

Moreover, the slits 18 are configured in the shape of a “U” when seen in a front elevation view and are disposed from the front sides (tilting distal end sides) of the assembly claws 16 to the rear sides (tilting base end sides) beyond the insertion holes 16A in the assembly claws 16 (the parts that engage with the insertion claws 26). For this reason, the assembly claws 16 can effectively be elastically tilted by the insertion claws 26, and the assembly load on the assembly body 12 (the rigid member 14) and the insertion body 24 can effectively be reduced.

Furthermore, the assembly claws 16 are provided in the tubular part (side walls) of the rigid member 14. For this reason, even in a case where the tubular part of the rigid member 14, in contrast to the tabular part, is not easily elastically deformed, the assembly claws 16 can easily be elastically deformed because the slits 18 are formed through the rigid member 14 around the assembly claws 16 as described above.

Moreover, the insertion claws 26 pass through the passage grooves 20 and the front portions of the slits 18 in the rigid member 14 to reach the assembly claws 16 (the abutment portions 16B). For this reason, the insertion claws 26 can reach the assembly claws 16 without deforming the rigid member 14, and the insertion claws 26 can easily be made to reach the assembly claws 16.

Furthermore, in the assembly body 12, the elastic member 22 limits the ingress of water into the rigid member 14 (the rigid member 14 side). For this reason, the ingress of water into the rigid member 14 can be limited.

In this embodiment, the slits 18 are provided on the front sides, the left sides, and the right sides of the assembly claws 16. However, the slits 18 may be provided on at least one of the front sides, the left sides, and the right sides of the assembly claws 16. Moreover, together with this, or instead of this, the slits 18 may also be provided on the rear sides of the assembly claws 16.

Furthermore, in this embodiment, the insertion holes 16A (assembly sites) are provided in the assembly claws 16 of the rigid member 14, and the insertion claws 26 (engagement portions) are provided on the insertion body 24. However, the insertion claws 26 (assembly sites) may also be provided on the assembly claws 16 of the rigid member 14, and the insertion holes 16A (engagement portions) may also be provided in the insertion body 24.

What is claimed is:

1. An assembly body comprising:
an assembly member that is provided with an assembly portion, has a through hole provided around the assembly portion, and to which an assembly partner is assembled as a result of the assembly portion being displaced and becoming engaged with an engagement portion of the assembly partner; and
a cover member that covers a side of the assembly member opposite an engagement portion side, is configured to be more elastic than the assembly member, and with its elasticity allows displacement of the assembly portion.

2. The assembly body of claim 1, wherein the assembly portion is configured to be tiltable, and the through hole is disposed from a tilting distal end side of the assembly portion to a tilting base end side beyond a part of the assembly portion that engages with the engagement portion.

3. The assembly body of claim 1, further comprising a passage portion that is provided at the assembly member and through which the engagement portion passes to reach the assembly portion.

4. The assembly body of claim 1, wherein the assembly portion is provided at a tubular part of the assembly member.

5. The assembly body of claim 1, wherein the cover member limits ingress of liquid to an assembly member side.

6. The assembly body of claim 1, wherein the through hole is disposed at both sides of the assembly portion in an assembly partner assembly direction.

7. The assembly body of claim 1, wherein an inclined surface is provided at an engagement portion reaching part of the assembly portion.
